(19) United States
(12) Patent Application Publication
(10) Pub. No.: US 2005/0043556 A1
(43) Pub. Date: Feb. 24, 2005

(54) Chiral ligands for asymmetric catalysis

(76) Inventors: Christophe Guillaume Malan, Basel (CH); Antonio Zanotti- Gerosa, Cambridge (GB); Julian Paul Henschke, Essex (GB)

Correspondence Address: Graham E. Taylor;The Dow Chemical Company, Intellectual Property, P O Box 1967, Midland, MI, 48641-1967, US

(21) Appl. No.: 10/493,990

(22) PCT Filed: Dec. 5, 2002
(86) PCT No.: PCT/IB02/05820

(30) Foreign Application Priority Data
Dec. 5, 2001 (GB) 0129112.9

(51) Int. Cl. C07F 15/00

(52) U.S. Cl. 556/136; 556/137

(57) ABSTRACT

The present invention is based around the discoveries that novel ligands of formula (4) and the opposite enantiomers thereof, (i) have utility as components of catalysts for asymmetric hydrogenation and (ii) are readily accessible by an efficient general synthetic route. In particular, ruthenium-diamine complexes of the ligands (4) are highly active and selective catalysts for the asymmetric hydrogenation of ketones.

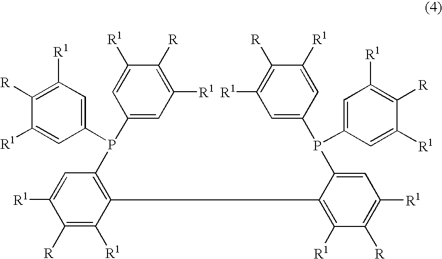

This invention relates to novel chiral ligands and to catalysts derived therefrom, which are useful in catalytic asymmetric hydrogenation reactions.

Homogeneous catalytic asymmetric hydrogenation is an important reaction for providing chiral intermediates for pharmaceutical agents and other products useful in the life sciences which are required in single isomer form. In particular, the reaction provides economically viable manufacturing processes since the raw materials can be inexpensive, the reaction conditions are simple and the catalyst may be used at a very low loading.

The diversity of substrates amenable to transformation into enantiomerically enriched chiral products by asymmetric hydrogenation means that a complementary range of catalysts is required in order to find the best match of catalyst and substrate for a given application. One class of catalysts that has received considerable attention is the transition metal complexes of biaryl diphosphine ligands. Ligands of general formulae 1 and 2 (FIG. 1) are representative examples. Such ligands exist as stable atropisomers, by virtue of hindered rotation about the C—C bond between the two aromatic groups bearing the diarylphosphino moieties. In particular, ruthenium complexes of the ligands are well suited to the asymmetric hydrogenation of C═X bonds, wherein X is a heteroatom, typically oxygen or nitrogen. Examples of substrates possessing such functionality include ketones, β-ketoesters, β-diketones and imines.

In recent years the asymmetric hydrogenation of ketones, especially simple aromatic ketones, has been developed into a viable industrial method for the manufacture of chiral alcohols, by using ruthenium catalysts bearing a chiral diphosphine and a chiral diamine (for a review see: Noyori and Okhuma, Angewandte. Chem. Int. Ed., 2001, 40, 41). Original reports of this method entail the use of ruthenium complexes in which the chiral diphosphine is a BINAP ligand of formula 1. An important observation in this work is that the presence of electron-donating substituents in the Ar group of the ligand 1 is required in order to produce chiral alcohols of sufficiently high enantiopurity for industrial utility, that is of at least 95 percent ee and preferably of at least 97 percent ee. For example (see table 2 in Noyori and Okhuma), in the hydrogenation of various ortho-, meta- and para-substituted acetophenones, catalysts containing Xyl-BINAP (1c) gave products with consistently higher enantioselectivity than those containing Tol-BINAP (1b); both systems gave higher enantioselectivity than catalysts containing the parent ligand 1a. Catalysts containing Xyl-BINAP also exhibited the highest activity. Steric factors may also contribute to the beneficial properties conferred by the Xyl (3,5-dimethylphenyl) units.

[image]

More recently, the development of highly active HexaPHEMP ligands 2 (Burk and Malan, WO 01/94359) has demonstrated that electron-donating alkyl substituents in the chiral biaryl backbone can also enhance the enantioselectivity obtainable in asymmetric ketone hydrogenation, as well as increasing the rate of reaction when compared with BINAP derivatives. In common with the BINAP series, ruthenium-diphosphine-diamine complexes of Xyl-HexaPHEMP (2b) usually give higher enantioselectivity than those containing the parent ligand 2a. However, despite these beneficial properties, the current synthetic route to Xyl-HexaPHEMP (2b) is inefficient and may limit its industrial applicability. As shown in Scheme 1, the synthetic route involves stepwise introduction of the two aryl phosphine units, as opposed to simultaneously introducing the units in one step as described for BINAP synthesis (Cai et al. J. Org. Chem. 1994, 59, 7180). This is generally found to be necessary when either the chiral backbone or the aryl group Ar possess electron-donating substituents (for a similar example in the synthesis of H₈-BINAP see: Kumobayashi et al. Synlett 2001, 1055). When the chiral backbone and the aryl groups both possess electron-donating substituents, as is the case for ligand 2b, this effect is compounded. In particular, the yield in the second C—P bond-forming reactions is lower for 2b than for 2a; in addition, the reagent HP(Xyl)₂ used is extremely prone to oxidation and therefore difficult to handle.

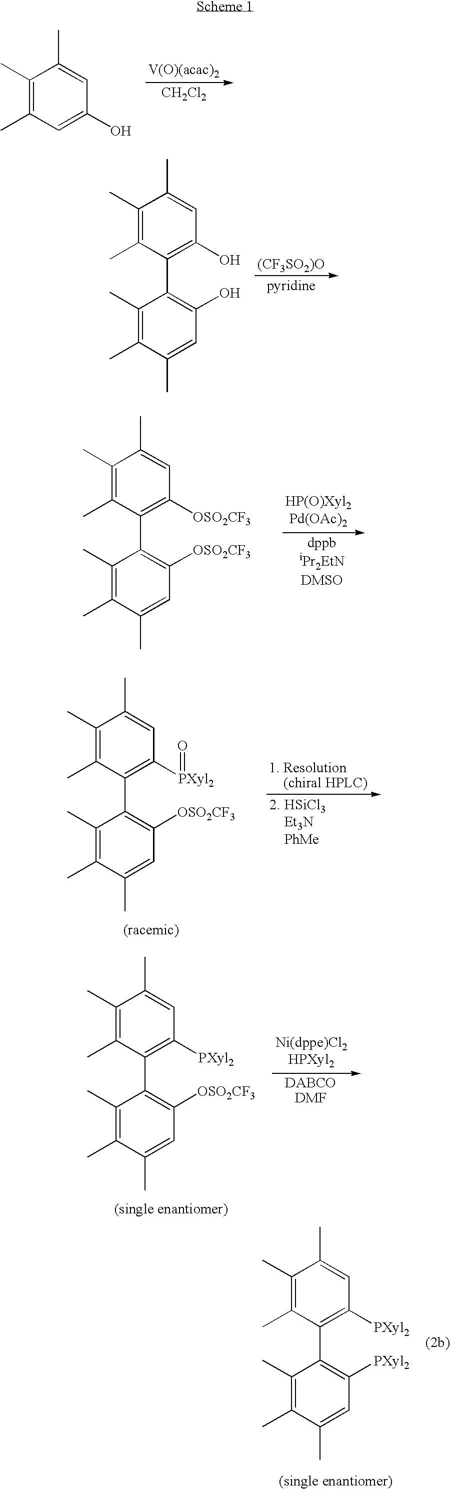

Thus, there is a need for chiral biaryl diphosphine ligands combining the advantages of having electron-donating substituents on the chiral backbone and the 3,5-disubstitution pattern in the arylphosphino groups, but in contrast to Xyl-HexaPHEMP (2b) are accessible by a more efficient synthetic route.

In U.S. Pat. No. 6,162,929, Foricher and Schmid describe a synthetic route to the biaryl diphosphine ligand 3, as depicted in Scheme 2, which is facilitated greatly by the well-known ortho-directing effect of the methoxy substituent in the course of the lithiation step, and stabilisation of the resultant aryllithium species prior to oxidative coupling. The principal attraction of this route is the avoidance of inefficient, stepwise C—P bond forming reactions. The effectiveness of ligand (3) as a catalyst component for catalytic hydrogenation of ketones is hitherto unreported.

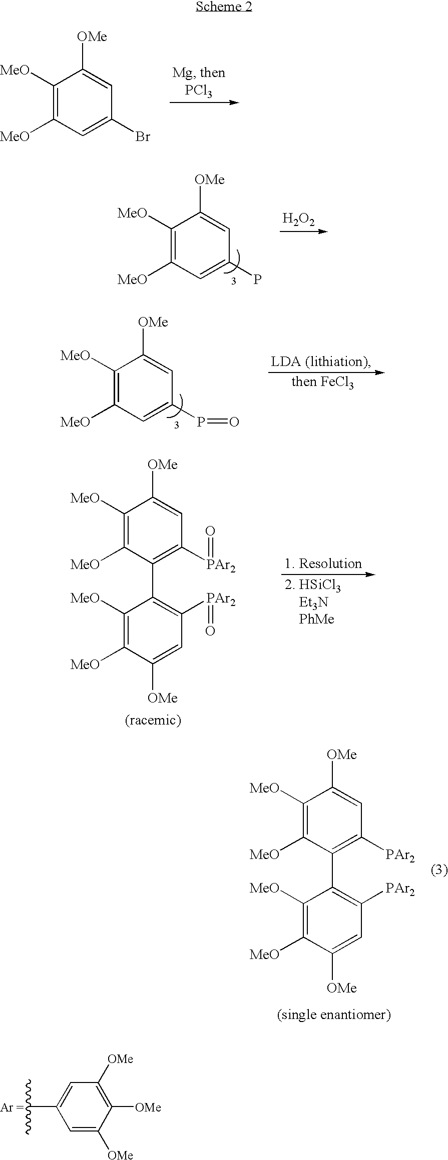

The present invention is based around the discoveries that novel ligands of formula 4, and the opposite enantiomers thereof, (i) have utility as components of catalysts for asymmetric hydrogenation and (ii) are readily accessible by an efficient general synthetic route.

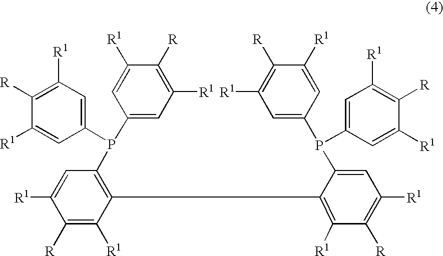

In particular, ruthenium-diamine complexes of the ligands 4 are highly active and selective catalysts for the asymmetric hydrogenation of ketones.

In formula 4, R¹ is alkyl and R is selected from the group consisting of H, alkyl, alkoxy, aryl, heteroaryl, N-alkyl, N-aryl, S-alkyl, S-aryl, OSi(alkyl)₃, OSi(aryl)₃, F and Cl. In preferred compounds of the present invention, comprising both ligands 4 and derived transition metal complexes, R¹ is methyl or C₁₋₆ n-alkyl, whereas R is H, C₁₋₆ alkyl or C₁₋₆ alkoxy. Especially preferred are the compounds wherein R¹ is methyl, R is either H or methoxy and the transition metal is ruthenium. Ruthenium complexes may be of the type Ru(6)X₂(DIA), wherein DIA is a diamine, preferably a chiral diamine, and X is selected from a group consisting of halide, carboxylate or hydride. As is evident from the Examples, such complexes have great utility as pre-catalysts and catalysts for the asymmetric hydrogenation of ketones.

A particular advantage of the present invention is that ligands of formula 4, and the opposite enantiomers thereof, can be assembled rapidly via a concise synthetic route, as depicted in Scheme 3. The overall strategy employs a phosphine oxide starting material that possesses three identical aryl groups. In the first step, the starting phosphine oxide is monolithiated, using a suitable alkyl- or aryllithium or other strong organometallic base. The anion is generated ortho- to phosphorus, by virtue of the directing effect of the P═O moiety. The ortho-directing effect of the P═O bond in aryl phosphine oxides has been reported in the literature, but hitherto has not been applied in the synthesis of chiral biaryl diphosphine compounds [in contrast, the similar approach to ligand (3) described in U.S. Pat. No. 6,162,929 relies primarily on the directing and anion-stabilising effect of an adjacent methoxy group]. The monolithiated product is then converted directly to an isolable aryl halide. Completion of the synthesis entails oxidative coupling of the aryl halide, using a standard Ullmann reaction, followed by reduction of the two phosphine oxide groups. A resolution step, to obtain separate enantiomers, can be implemented at various stages of the synthesis, for example by means of chromatographic resolution or formation and physical separation (crystalllisation or chromatography) of diastereoisomeric derivatives.

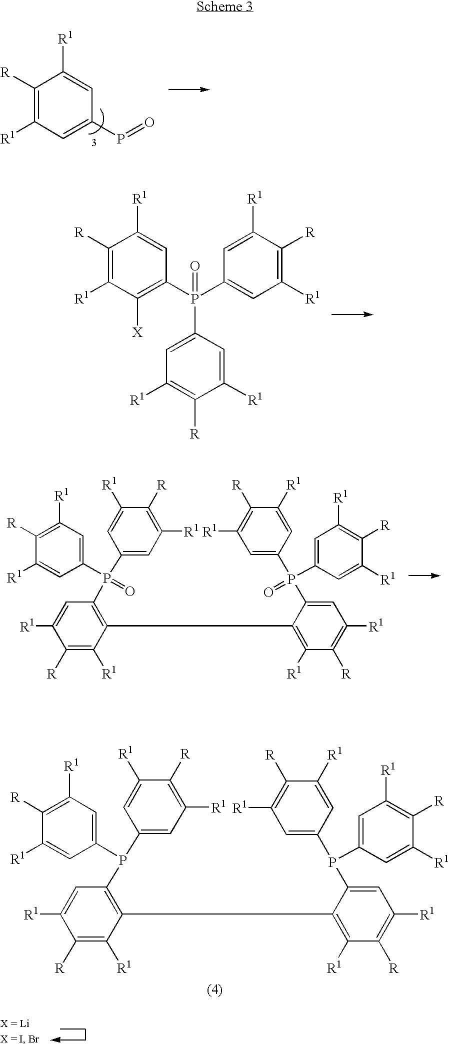

The phosphine oxide starting material employed in the process to make a ligand (6) is easily accessed, for example from the corresponding aryl halide as illustrated in Scheme 4.

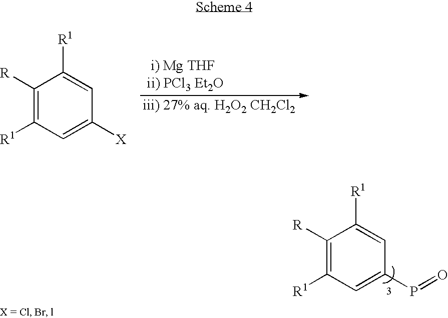

[image]

In preferred embodiments of the present invention, the synthetic approach outlined in Scheme 3 has been applied to obtain novel ligands Xyl-TetraPHEMP (5) and Xyl-MeO—BIMOP (6) (FIG. 2). Scheme 4 depicts the overall route to ligand 5, including resolution of racemic-5 by means of diastereomeric palladium salts incorporating (R)—N,N-dimethyl-1-methylbenzylamine.

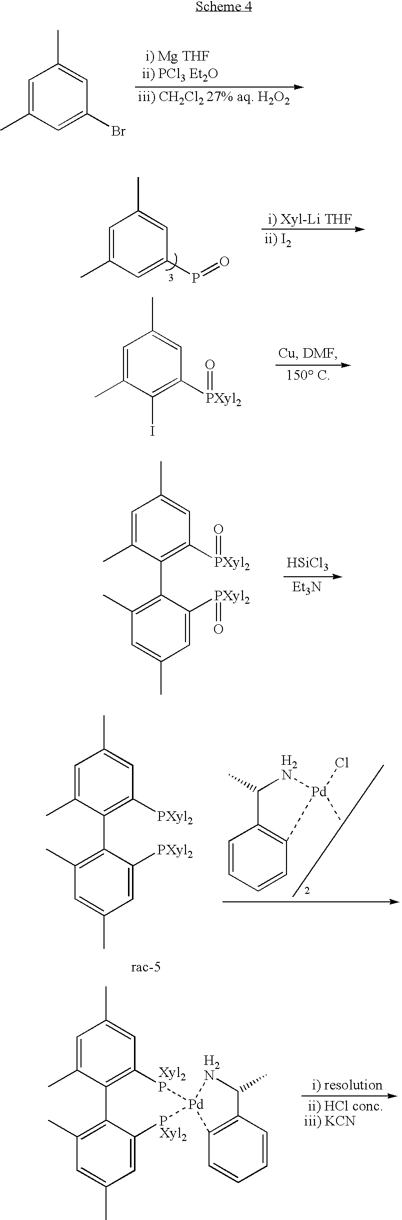

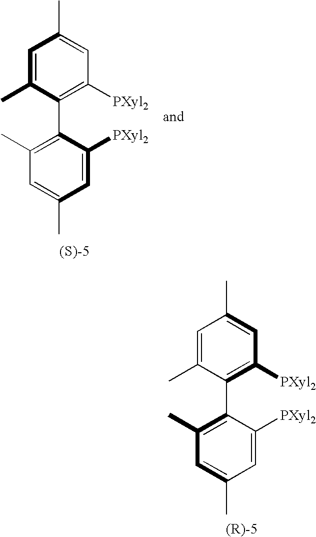

For initial investigation of the utility of ligand (5), pre-catalysts of the type RuCl₂(5)(DIA) (DIA=EDA or (S,S)-DPEN) were prepared according to literature methodology (Scheme 5) (Noyori et al. Angew. Chem. Int. Ed. 1998, 37, 1703) and shown to be highly active in the hydrogenation of acetophenone. In comparison, the BINAP-containing complexes RuCl₂(1a)(DIA) [DIA=EDA or (S,S)-DPEN] were considerably less active and a complex based on ligand (3), RuCl₂(3)(DIA) (DIA=EDA), was essentially inactive.

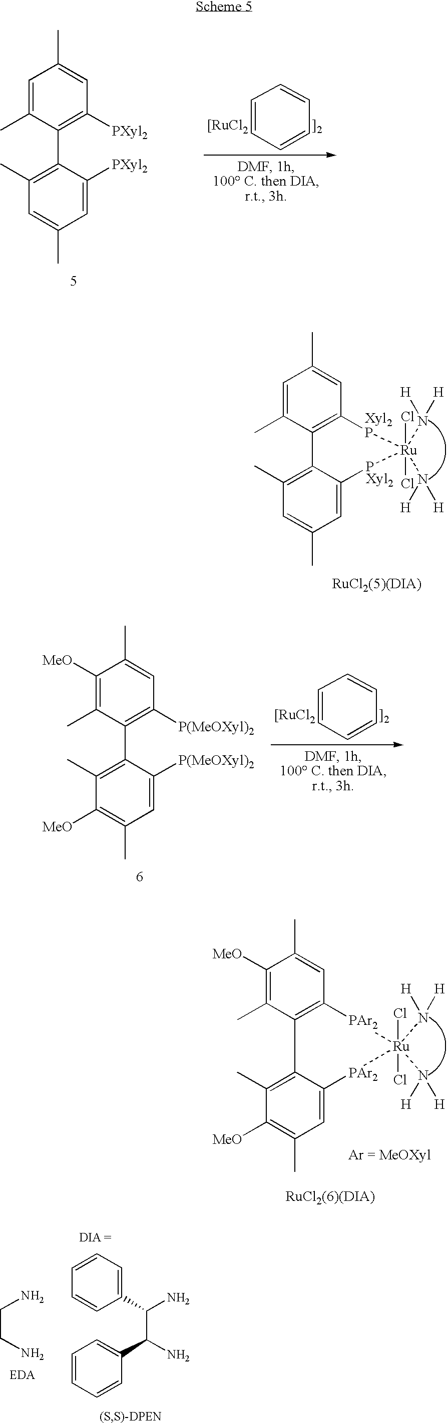

In the investigation of ligands (5) and (6) as single enantiomers, the pre-catalysts [(S)-5]RuCl₂[(S,S)-DPEN] and [(S)-6]RuCl₂[(S,S)-DPEN], and their respective mirror image forms, were identified as providing the preferred combination (“matched pair”) of phosphine and diamine enantiomers for asymmetric hydrogenation of ketone. These complexes were compared with the analogous ‘matched’ complex of the known Xyl-HexaPHEMP ligand, [(R)-2b]RuCl₂[(R,R)-DPEN], in the hydrogenation of acetophenone and other aromatic and heteroaromatic ketones (Table 1). The catalysts derived from Xyl-TetraPHEMP (5) and Xyl-MeO—BIMOP (6) produced comparable activity and the same level of selectivity (>97 percent e.e.) obtainable with Xyl-HexaPHEMP in the hydrogenation of acetophenone. Unexpectedly, improved levels of selectivity were observed on the less reactive substrates 2-acetylpyridine (with 5) and 2-methylbenzophenone (with 5 and 6).

TABLE 1

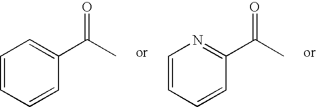

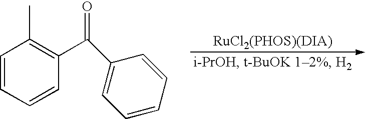

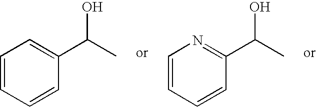

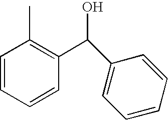

| | Acetophenone | 2-Acetylpyridine | 2-Methylbenzophenone |
|---|---|---|---|
| [(R)-5]RuCl₂[(R,R)-DPEN] | 99% e.e. | 86% e.e. | 62% e.e. |
| [(S)-6]RuCl₂[(S,S)-DPEN] | 97% e.e. | 52% e.e. | 62% e.e. |
| [(S)-2b]RuCl₂[(S,S)-DPEN] | 99% e.e. | 76% e.e. | 52% e.e. |

The following examples illustrate the present invention.
Examples 1-8: the synthesis and resolution of Xyl-TetraPHEMP 5 are described.
Examples 9-12: the preparation of ruthenium complexes of general formula Ru(5)X₂(DIA) is described.
Examples 13-18: the synthesis and resolution of MeO-Xyl—BIMOP 6 are described.
Examples 19-20: the preparation of ruthenium complexes of general formulae Ru(5)X₂(DIA) and Ru(6)X₂(DIA) is described.
Examples 21-22: the hydrogenation of acetophenone with precatalysts produced from racemic Xyl-TetraPHEMP (5), racemic BINAP (1a) and phosphine 3 is described. The catalysts bearing Xyl-TetraPHEMP show increased activity with respect to BINAP-based catalysts. The catalyst based on phosphine 3 is inactive.
Examples 23-24: the hydrogenation of acetophenone with Ru(5)X₂(DIA) and Ru(6)X₂(DIA) is described. These experiments were aimed at identifying the ‘matching’ and ‘mis-matching’ pairs of phosphine and diamine ligands.
Examples 25-26: the asymmetric hydrogenation of acetophenone with ‘matching’ catalysts Ru(8)X₂(DIA) and Ru(9)X₂(DIA) demonstrated that enantioselectivities comparable with that obtainable with one of the best available catalysts (based on Xyl-HexaPHEMP 2b) are achieved.
Example 27-28: the hydrogenation of 2-acetylpyridine and 2-methylbenzophenone with precatalysts Ru(5)X₂(DIA), Ru(6)X₂(DIA) and Ru(2b)X₂(DIA) indicated that on specific substrates catalysts based on Xyl-TetraPHEMP and MeO-Xyl—BIMOP induce higher levels of enantioselectivity than Xyl-HexaPHEMP.

### EXAMPLE 1

### tris(3.5-Dimethylphenyl)phosphine oxide

Magnesium turnings were placed in an oven dried 3-neck round-bottom flask and were washed twice with heptane (100 mL each) and then twice with diethyl ether (50 mL each). The final traces of solvent were removed under reduced pressure followed by oven (110° C.) drying for 15 minutes. A condenser was fitted to the round-bottom flask and the contents were allowed to cool to room temperature under an atmosphere of nitrogen. After the addition of anhydrous tetrahydrofuran (40 mL), 1-bromo-3,5-dimethylbenzene (13.62 g, 73.6 mmol) was added at such a rate that the mixture maintained a gentle reflux. Once the neat addition was complete, 1-bromo-3,5-dimethylbenzene (54.48 g, 294.4 mmol) in tetrahydrofuran (100 mL) was added over a 1 hour period. The mixture was then allowed to stir at room temperature for 2 hours. The solution was cooled to 0° C. and a solution of phosphorous trichloride (11.26 g, 82.0 mmol) in diethyl ether (40 mL) was added slowly. The mixture was stirred at room temperature for 20 hours. The product mixture was cooled to 0° C. and distilled water (100 mL) was cautiously added. After the mixture had been stirred for 10 minutes, tert-butyl methyl ether (400 mL) was added and the aqueous and organic phases were separated. The aqueous phase was acidified with dilute hydrochloric acid, diluted with brine (200 mL) and extracted with methyl tert-butyl ether (200 mL). The organic fractions were combined, washed with brine (200 mL), dried (magnesium sulfate), filtered and evaporated to provide a yellow solid. The yellow solid was directly dissolved in dichloromethane (200 mL) and added to an oven dried 3-neck round-bottom flask and cooled to 0° C. A 27 percent aqueous solution of hydrogen peroxide (94.3 mL) was cautiously added and the mixture stirred for 1.5 hours. The aqueous phase was separated and the organic fraction was washed with brine (100 mL), an aqueous solution of sodium metabisulfite (100 mL), brine (100 mL), dried (magnesium sulfate), filtered and evaporated to furnish a solid. The product was dissolved in boiling heptane (80 mL) and was allowed to cool to room temperature. The yellow solution was decanted leaving the title compound as a white solid (22.83 g, 62.99 mmol, 77 percent based on phosphorous trichloride). ¹H NMR (400 MHz, CDCl₃) δ 2.31 (18 H, s, CH₃), 7.15 (3 H, s, ArH), 7.26 (3H, s, ArH), 7.29 (3H, s, ArH); ³¹P NMR (162 MHz, CDCl₃) .δ 30.9 ppm; ¹³C NMR (100 MHz, CDCl₃) .δ 21.2, 129.5 (d, J=9.8 Hz), 131.9, 133.0, 133.4 (d, J=2.5 Hz), 137.9 (d, J=12.7). LCMS (APCi: MeCN/H₂O) 363 (100 percent, M+H)⁺.

### EXAMPLE 2

### bis(3,5-dimethylphenyl)-(2-iodo-3,5-dimethylphenyl)phosphine oxide

To a cooled (−78° C.) solution of 1-bromo-3,5-dimethylbenzene (775 mg, 4.19 mmol) in degassed, anhydrous tetrahydrofuran (6 mL) was added tert-butyl lithium in pentane (1.7 M, 4.93 mL, 8.38 mmol) dropwise under an atmosphere of nitrogen. The mixture was stirred at −78° C. for 40 minutes and was then added, via cannula, to a cooled (−78° C.) solution of tri(3,5-dimethylphenyl)phosphine oxide (460 mg, 1.27 mmol) in anhydrous tetrahydrofuran (6 mL). The deep red solution was warmed to −20° C. and stirred for 2.5 h at this temperature. The solution was cooled to −78° C. and a solution of iodine (1.17 g, 4.61 mmol) in anhydrous tetrahydrofuran (7.5 mL) was added dropwise. The solution was allowed to warm to room temperature and was left to stir for 18 h. The product mixture was diluted with dichloromethane (90 mL) and was washed with aqueous sodium thiosulfate (20 mL), distilled water (30 mL), brine (30 mL), dried (magnesium sulfate), filtered and evaporated to give a tan-coloured syrup (727 mg). This was chromatographed on a column of silica gel eluting with 60 percent tert-butyl methyl ether in heptane providing the title product as a white foam (459 mg, 0.94 mmol, 74 percent). ¹H NMR (400 MHz, CDCl₃) .δ 2.09 (3H, s, CH₃), 2.24 (12H, s, CH₃), 2.37 (3H, s, CH₃), 6.72 (1H, appears as two 0.5H finely slip signals at 6.70 and 6.73, ArH), 7.07 (2H, s, ArH), 7.11 (1H, s, ArH), 7.20 (2H, s, ArH), 7.23 (2H, s, ArH); ³¹P NMR (162 MHz, CDCl₃) .δ 36.1; LCMS (APCi: MeCN/H₂O) 489 (100 percent, M+H)⁺, 490 (30 percent).

### EXAMPLE 3

### rac-4,4′,6,6′-Tetramethyl-2,2′-bis[bis(3,5-dimethylphenyl)phosphinoyl]-biphenyl

A mixture of bis(3,5-dimethylphenyl)-(2-iodo-3,5-dimethylphenyl)phosphine oxide (2.00 g, 4.10 mmol), activated copper powder (0.78 g, 12.29 mmol) and anhydrous, degassed N,N-dimethylformamide (20 mL) was heated (oil bath temperature of 150° C.) under a nitrogen atmosphere for 5.5 h. The product mixture was allowed to cool to room temperature, filtered and evaporated giving a an oily residue that was washed with dichloromethane (10 mL). The solvent was evaporated providing an off-white foam (1.66 g). This was chromatographed on a column of silica gel eluting with 65 percent tert-butyl methyl ether in heptane providing 1.39 g of the title compound as a white foam (1.92 mmol, 94 percent). ¹H NMR (400 MHz, CDCl₃) .δ 1.68 (6H, s, CH₃), 2.03 (12H, s, CH₃), 2.21 (6H, s, CH₃), 2.29 (12H, s, CH₃), 6.85 (2H, s, ArH), 6.93 (2H, s, ArH), 7.09 (5H, s, ArH), 7.12 (3H, s, ArH), 7.34 (2H, s, ArH), 7.37 (2H, s, ArH); ³¹P NMR (162 MHz, CDCl₃) .δ 31.1 ppm; LCMS (APCi: MeCN/H₂O) 723 (100 percent, M+H)⁺, 724 (53 percent).

### EXAMPLE 4

### rac4,4′,6,6′-Tetramethyl-2,2′-bis[bis(3,5-dimethylphenyl)phosphino]-biphenyl: (rac)-XylTetraPHEMP 5

To a solution of 6,6′-bis[bis(3,5-dimethylphenyl)phosphinoyl]-2,4,2′,4′-tetramethylbiphenyl (1.00 g, 1.38 mmol) in anhydrous p-xylene (15 mL) in a 100 mL Schlenk flask fitted with a reflux condenser was added triethylamine (3.09 g, 30.57 mmol) and then trichlorosilane (3.93 g, 29.05 mmol). The heterogeneous orange mixture was heated to 130° C. (oil bath temperature) over a 20 minute period and then stirred at this temperature for 5 hours under a nitrogen atmosphere. The reaction was allowed to cool to room temperature and a 30 percent aqueous solution of sodium hydroxide (30 mL) was cautiously added and the mixture stirred for 15 minutes. The aqueous and organic layers were separated and the aqueous fraction was extracted three times with tert-butyl methyl ether (15 mL each). The combined organic fractions were dried (sodium sulfate), filtered under a nitrogen atmosphere and evaporated to give a white foam. ¹H NMR spectroscopic analysis indicated that the reduction was only 70 percent complete. The product was chromatographed on a column of silica gel providing the desired product as a white foam (222 mg, 0.30 mol, 22 percent). ¹H NMR (400 MHz, CDCl₃) .δ 1.51 (6H, s, CH₃), 2.12 (12H, s, CH₃), 2.22 (12H, s, CH₃), 2.26 (6H, s, CH₃), 6.77 (2H, s, ArH), 6.80 (4H, m, ArH), 6.86 (4H, m, ArH), 6.89 (2H, s, ArH), 6.92 (2H, s, ArH), 6.95 (2H, s, ArH); ³¹P NMR (162 MHz, CDCl₃) .δ-13.4 ppm; LCMS (APCi: MeCN/H₂O) 691 (100 percent, M+H)⁺, 692 (58 percent).

### EXAMPLE 5

### {(R)—N,N-Dimethyl(1-methyl)benzylaminato-C²,N]}-{rac-4,4′,6,6′-tetramethyl-2,2′-bis[bis(3,5-dimethylphenyl)phosphino]-biphenyl}-palladium(II) tetrafluoroborate

rac4,4′,6,6′-Tetramethyl-2,2′-bis[bis(3,5-dimethylphenyl)phosphino]-biphenyl (1.28 g, 1.85 mmol) and di-μ-chloro-bis[(R)-dimethyl(1-methyl)benzylaminato-C²,N]dipalladium(II) (0.63 g, 1 mmol) were dissolved in methanol (80 mL) and stirred at 45° C. for 6 hours. The clear solution was stirred at room temperature for further two days, then NaBF₄ (0.96 g, 8.7 mmol) was added. The reaction was heated to 45° C. for 2 hours, then the solvent was concentrated under reduced pressure to ˜10 mL. Water (50 mL) was added. A solid precipitated and was collected by filtration (crop 1). The mother liquor was extracted with dichloromethane (3×50 mL). The solid obtained in crop 1 was dissolved in dichloromethane (50 mL) and all the organic fractions combined and dried over magnesium sulphate, filtered and evaporated to produce a pale yellow solid residue (1.69 g, 92 percent yield). ³¹P NMR (400 MHz, CDCl₃) .δ 39.8 (d, J=45 Hz), 39.2 (d, J=45 Hz), 11.8 (d, J=45 Hz), 9.7 (d, J=45 Hz).

### EXAMPLE 6

### Chromatographic Separation of Diastereoisomeric Palladium Salts

{(R)—N,N-Dimethyl(1-methyl)benzylaminato-C²,N]}-{rac-4,4′,6,6′-tetramethyl-2,2′-bis[bis(3,5-dimethylphenyl)phosphino]-biphenyl)-palladium(II) tetrafluoroborate (2.19 g, 2.20 mmol) was separated by chromatography (eluent: t-butylmethylether/toluene 4/1) to produce 0.925 g of the first diastereoisomer (42 percent yield) and 0.94 g of the second eluted diastereoisomer (44 percent yield).

First eluted diastereoisomer: {(R)—N,N-Dimethyl(1-methyl)benzylaminato-C²,N]}-{(S)-4,4′,6,6′-tetramethyl-2,2′-bis[bis(3,5-dimethylphenyl)phosphino]-biphenyl-palladium(II) tetrafluoroborate ³¹P NMR (400 MHz, CDCl₃) .δ 39.8 (d, J=45 Hz), 39.2 (d, J=45 Hz), 11.8 (d, J=45 Hz), 9.7 (d, J=45 Hz); ¹H NMR (400 MHz, CDCl₃) distinctive signal at .δ 5.15 (q, N—CH—CH₃).

Second eluted diastereoisomer: {(R)—N,N-Dimethyl(1-methyl)benzylaminato-C²,N]}-{(R)-4,4′,6,6′-tetramethyl-2,2′-bis[bis(3,5-dimethylphenyl)phosphino]-biphenyl}-palladium(II) tetrafluoroborate ³¹P NMR (400 MHz, CDCl₃) .δ 39.2 (d, J=45 Hz), 11.8 (d, J=45 Hz); ¹H NMR (400 MHz, CDCl₃) distinctive signal at .δ 3.5 (m, N—CH—CH₃).

### EXAMPLE 7

### (S)-4,4′,6,6′-Tetramethyl-2,2′-bis[bis(3,5-dimethylphenyl)phosphino]-biphenyl: (S)-Xyl-TetraPHEMP 5

{(R)—N,N-Dimethyl(1-methyl)benzylaminato-C²,N]}-{(S)-4,4′,6,6′-tetramethyl-2,2′-bis[bis(3,5-dimethylphenyl)phosphino]-biphenyl}-palladium(II) tetrafluoroborate (0.91 g, 0.91 mmol) was dissolved in anhydrous dichloromethane (30 mL). Hydrochloric acid (37 percent, 1.5 mL) was added and the reaction was stirred at room temperature for 2.5 hours. The dichloromethane solution was washed with degassed water (30 mL), sodium hydrogen carbonate saturated solution (30 mL) and more water (3×30 mL). Potassium cyanide (0.95 g, 14.6 mmol) and degassed water (10 mL) were added and the reaction was stirred for 5 hours at room temperature. The aqueous layer was removed and the dichloromethane solution was washed with degassed water (5×30 mL) then evaporated to dryness. Sodium sulfate anhydrous was added to the resulting off white solid residue and the mixture of solids was extracted with anhydrous toluene (3×20 mL). The toluene solution was filtered through a 5 cm silica gel plug. Evaporation of the solvent gave 0.38 g of product (60 percent yield). All operations were carried out under nitrogen atmosphere. All aqueous solutions and contaminated glassware were quenched with bleach.

The spectroscopic data resulted identical to the ones observed for the racemic mixture. A sample was oxidised with hydrogen peroxide and analysed by HPLC for enantiomeric purity: e.e. >98 percent.

### EXAMPLE 8

### (R)-4,4′,6,6′-Tetramethyl-2,2′-bis[bis(3,5-dimethylphenyl)phosphino]-biphenyl: (R)-XylTetraPHEMP 5

The title compound was prepared by a reaction analogous to Example 7; ¹P NMR (162 MHz, CDCl₃) .δ-13.4.

### EXAMPLE 9

### RuCl₂[(rac)4,4′,6,6′-Tetramethyl-2,2′-bis[bis(3,5-dimethylphenyl)phosphino]-biphenyl[-]ethylenediamine]: RuCl₂[(rac)-XylTetraPHEMP][EDA]

rac4,4′,6,6′-Tetramethyl-2,2′-bis[bis(3,5-dimethylphenyl)phosphinoyl]-biphenyl (100 mg, 0.14 mmol) was allowed to react with the benzeneruthenium(II) chloride dimer (36 mg, 0.07 mmol) in N,N-dimethylformamide (2 mL) at 100° C. for 3 h then at room temperature with ethylene diamine (9.6 mg, 0.16 mmol) for 105 minutes. The N,N-dimethylformamide was evaporated and the product was dissolved in anhydrous dichloromethane (5 mL). The solvent was evaporated and the product was again dissolved in dichloromethane (5 mL) and then evaporated giving a khaki-coloured foam. ³¹P NMR (162 MHz, CDCl₃) .δ 44.3 ppm.

### EXAMPLE 10

### RuCl₂[(rac)-XylTetraPHEMP][(S,S)-DPEN]

The title complex was prepared as described in the supporting information and as published (Noyori et al., J. Am. Chem Soc. 1998, 40, 13529). Rac6,6′-bis[bis-(3,5-dimethylphenyl)phosphanyl]-2,4,2′,4′-tetramethylbiphenyl (100 mg, 0.14 mmol) was allowed to react with the benzeneruthenium(II) chloride dimer (36 mg, 0.07 mmol) in N,N-dimethylformamide (2 mL) at 100° C. for 1 h then at room temperature with (S,S)-1,2-diphenylethane-1,2-diamine (34 mg, 0.16 mmol) for 16 hours. The N,N-dimethylformamide was evaporated and the product was dissolved in anhydrous dichloromethane (4 mL). The solvent was evaporated and the product was again dissolved in dichloromethane (4 mL) and then evaporated giving a tan-coloured solid. ³¹P NMR (162 MHz, CDCl₃) .δ 44.3, 45.1 ppm. ¹H NMR spectroscopy revealed a 0.96:1.00 mixture of diastereoisomers.

### EXAMPLE 11

### RuCl₂[(R)-XylTetraPHEMP][(R,R)-DPEN]

A Schlenk tube under nitrogen containing 100 mg (0.14 mmol) of (R)-XylTetraPHEMP and 44.3 mg (0.072 mmol) of [(p-cymene)RuCl₂]₂ and 5 ml of dry, degassed N,N-dimethylformamide was heated to 110° C. for 3 hours before 35 mg (0.14 mmol) of (R,R)-DPEN were added in portion. The dark red/brown solution turned yellow. The solution was stirred for 1 hour more cooling to RT. N,N-Dimethylformamide was removed under reduced pressure. The crude product was dissolved in degassed acetone and filtered under nitrogen through a plug of silica. Evaporation of the filtrate gave the product as an orange/yellow solid. The yield was 78 mg, 50 percent. ³¹P NMR (162 MHz, CDCl₃) .δ 45.1 ppm.

### EXAMPLE 12

### RuCl₂[(R)-XylTetraPHEMP][(S,S)-DPEN]

A Schlenk tube under nitrogen containing 100 mg (0.14 mmol) of (R)-XylTetraPHEMP and 44.3 mg (0.072 mmol) of [(p-cymene)RuCl₂]₂ and 5 ml of dry, degassed N,N-dimethylformamide was heated to 110° C. for 3 hours before 35 mg (0.14 mmol) of (S,S)-DPEN were added in portion. The dark red/brown solution turned yellow. The solution was stirred for 1 hour more cooling to RT. N,N-Dimethylformamide was removed under reduced pressure. The crude product was dissolved in degassed acetone and filtered under N₂ through a plug of silica. Evaporation of the filtrate gave the product as an orange/yellow solid. The yield was 81 mg, 52 percent. ³¹P NMR (162 MHz, CDCl₃) .δ 43.7 ppm.

### EXAMPLE 13

### Tris(3,5-dimethyl-4-methoxyphenyl)phosphine oxide

Magnesium turnings (6.7 g, 0.276 mol) were placed in a 250 ml Schlenk tube under nitrogen, and were dry stirred for 60 minutes. 50 mL Of dry, degassed tetrahydrofuran was added. 4 mL (5.52 g, 0.026 mol) of 1-bromo-2,3-dimethyl-4-methoxybenzene were added over 8 minutes and left to stir for 15 minutes. The remaining 25 mL (34.5 g, 0.064 mol) of 1-bromo-3,5-dimethyl-4-methoxybenzene was added over 15 minutes. The solution was stirred for 1.5 hours. The solution of the Grignard reagent was cooled to 0° C. before a solution of distilled PCl₃ (3.57 mL, 0.041 mol) in 20 ml of dry diethyl ether was added dropwise. The reaction was quenched with deionised water (20 mL). The reaction mixture was filtered and all volatiles were removed in vacuo. The solid was dissolved in dichloromethane (100 mL) and cooled to 0° C. before 23 mL of 30 percent H₂O₂ were added over 1 hour. The reaction mixture was stirred for 1 hour before the organic and aqueous layers were separated. The organic layer was washed with saturated NaCl and dried over MgSO₄. The material was filtered and the solvent removed in vacuo. The residues were treated with 50 mL of heptane at reflux followed by cooling to room temperature and subsequent filtering. The white solid was washed with heptane and dried under vacuum to give 14.03 g of the product (51 percent yield). ¹H NMR (400 MHz, CDCl₃) .δ 2.28 (18 H, s, CH₃), 3.75 (9 H, s, CH₃O), 7.31 (6 H, d, ArH); ³¹ P NMR (162 MHz, CDCl₃) .δ 29.6 ppm.

### EXAMPLE 14

### Bis(3,5-dimethyl-4-methoxyphenyl)-(2-iodo-3,5-dimethyl-4-methoxyphenyl)phosphine oxide

1-Bromo-2,3-dimethyl-4-methoxybenzene (9.79 g, 45.52 mmol) in 55 mL of dry tetrahydrofuran in a Schlenk tube at −78° C. under nitrogen was treated with 53.56 mL of 1.7M t-BuLi (91.05 mmol) over 50 minutes to form the aryl-lithium species. The aryl-lithium solution was added to a solution of 6.24 g (13.79 mmol) of the phosphine oxide at −78° C. via cannula needle to give a purple solution which was warmed to −20° C. and stirred for 3.5 hours. The purple solution was cooled to −78° C. and to this solution was added a solution of 12.86 g (50.67 mmol) of iodine in 55 mL tetrahydrofuran at −78° C. over 25 mins. The reaction mixture was left to warm to room temperature before the solvent was removed in vacuo to give a brown oil. The oil was dissolved in 50 mL of dichloromethane and mounted onto a 10 cm×15 cm pad of silica and washed with 1/1 heptane/t-butyl methyl ether to remove non-polar impurities before washing with 9/1 t-butyl methyl ether/ethyl acetate through to 1/1 t-butyl methyl ether/ethyl acetate to remove the product. The solution of product was washed with aqueous Na₂S₂O₃ and water before separating the layers and drying with MgSO₄ and filtering. The solvent was removed in vacuo and the product was slurried in 10 mL of Et₂O and 40 ml of heptane at −20° C. and left for 12 hours before filtering and washing with heptane. The white solid was dried under vacuum to give 4.71 g of product (59 percent yield). ¹H NMR (400 MHz, CDCl₃) .δ 2.14 (3H, s, CH₃), 2.28 (12H, s, CH₃), 2.45 (3H, s, CH₃), 3.71 (3H , s, CH₃O), 3.74 (12H, s, CH₃O), 3.76 (3H, s, CH₃O), 6.95 (1H, d, ArH), 7.32 (4H, d, ArH); ³¹P NMR (162 MHz, CDCl₃) .δ 34.81 ppm.

### EXAMPLE 15

### rac-4,4′,6,6′-tetramethyl-5,5′-dimethoxy-2,2′-bis[bis(3,5-dimethyl-4-methoxyphenyl)phosphinoyl]-biphenyl MeOXylBIMOPO

Bis(3,5-dimethyl-4-methoxyphenyl)-(2-iodo-3,5-dimethyl-4-methoxyphenyl) phosphine oxide (4.715 g, 8.15 mmol) and copper(I) thiophen-2-carboxylate (CuTC, 4.7 g, 24.65 mmol)) were treated with 35 mL of dry degassed N-methyl pyrrolidone in a Schlenk tube under nitrogen. The reaction mixture formed a green suspension. After stirring for 2 hours the suspension was brown. The reaction proceeded for 14 hours before the reaction mixture was filtered through celite and washed with diethyl ether and ethyl acetate. The solvent was removed in vacuo and the N-methyl pyrrolidone removed at reduced pressure. The residue was purified by column chromatography on a 10×10 cm column of silica using 1/1 dichloromethane/diethyl ether as the eluent. This gave 1.55 g of the product (42 percent yield). ¹H NMR (400 MHz, CDCl₃) .δ 1.43 (6H, s, CH₃), 2.12 (12H, s, br, CH₃), 2.23 (18H, s, br, CH₃), 3.58 (6H, s, CH₃O), 3.67 (6H, s, CH₃O), 3.73 (6H, s, CH₃O), 7.08 (2H, d, ArH), 7.33 (8H, φt, ArH); ³¹P NMR (162 MHz, CDCl₃) .δ 28.19 ppm.

### EXAMPLE 16

### rac4,4′,6,6′-tetramethyl-5,5′-dimethoxy-2,2′-bis[bis(3,5-dimethyl-4-methoxyphenyl)phosphino]-biphenyl MeOXylBIMOP 6

rac-4,4′,6,6′-Tetramethyl-5,5′-dimethoxy-2,2′-bis[bis(3,5-dimethyl-4-methoxyphenyl)phosphinoyl]-biphenyl (1 g, 1.107 mmol) was dissolved in 15 mL dry, degassed toluene and cooled to 0° C. in a Schlenk tube under nitrogen and was treated with 1.84 ml (13.2 mmol) of triethylamine followed by 1.2 ml (11.9 mmol) of trichlorosilane. The solution was heated to 105-110° C. for 12 hours. After cooling to room temperature the reaction was quenched with 5 g of silica and filtered under nitrogen. The solvent was removed in vacuo before filtering once more through a pad of silica eluting with diethyl ether. The solvent was removed in vacuo to give the product as a white solid (754 mg, 78 percent yield). ¹H NMR (400 MHz, CDCl₃) .δ2.09 (12H, s, CH₃), 2.11 (12H, s, CH₃), 2.13 (6H, s, CH₃), 2.16 (6H, s, CH₃), 3.34 (6H, s, CH₃O), 3.62 (12H, s, CH₃O), 6.78 (4H, φt, ArH), 6.89 (2H, d, ArH); ³¹P NMR (162 MHz, CDCl₃) .δ-15.64 ppm.

### EXAMPLE 17

### {(R)—N,N-dimethyl(1-methyl)benzylaminato-C²,N]}—{(S)-4,4′,6,6′-tetramethyl-5,5′-dimethoxy-2,2′-bis[bis(3,5-dimethyl-4-methoxyphenyl)phosphino]-biphenyl}-palladium(II) tetrafluoroborate

rac-4,4′,6,6′-Tetramethyl-5,5′-dimethoxy-2,2′-bis[bis(3,5-dimethyl-4-methoxyphenyl)phosphino]-biphenyl (0.75 g, 0.86 mmol) and di-μ-chloro-bis[(R)-dimethyl(1-methyl)benzylaminato-C²,N]dipalladium(II) (0.285 g, 0.45 mmol) were dissolved in methanol (30 mL) and dichloromethane (12 mL) in a Schlenk tube under nitrogen and stirred at room temperature for 2.5 hours. Sopdium tetrafluoroborate (0.65 g, 5.9 mmol) was added and the reaction was stirred at room temperature for 18 hours. The solvent was evaporated under reduced pressure and redissolved in 30 mL of dichloromethane. The organic solution was washed with water (analytical grade to avoid chloride anion contamination, 3×30 mL)., then dried over magnesium sulphate and filtered. The crude residue was purified by chromatography on silica (eluent: acetone/toluene 3/7). A small amount of the first eluted diastereoisomer was isolated (50 mg, 7 percent yield) and was found to be pure by ³¹P NMR analysis. Mixture of diastereoisomers: 31P NMR (400 MHz, CDCl₃) .δ 37.6 (d, J=46 Hz), 36.8 (d, J=46 Hz), 10.2 (d, J=46 Hz), 8.2 (d, J=46 Hz). First eluted diastereoisomer: ³¹P NMR (400 MHz, CDCl₃) .δ 37.6 ppm (d, J=46 Hz), 8.2 ppm (d, J=46 Hz).

### EXAMPLE 18

### (S)-4,4′,6,6′-tetramethyl-5,5′-dimethoxy-2,2′-bis[bis(3,5-dimethyl-4-methoxyphenyl)phosphino]-biphenyl:(S)-MeO-Xyl—BIMOP 6

{(S)—N,N-Dimethyl(1-methyl)benzylaminato-C²,N]}-{(S)-4,4′,6,6′-tetramethyl-5,5′-dimethoxy-2,2′-bis[bis(3,5-dimethyl-4-methoxyphenyl)phosphino]-biphenyl}-palladium(II) tetrafluoroborate (0.26 g, 0.20 mmol) was dissolved in 30 mL of anhydrous dichloromethane in a Schlenk tube under nitrogen. Hydrochloric acid (37 percent, 0.2 mL) was added and the reaction was stirred at room temperature for 1.5 hours. The dichloromethane solution was washed with degassed water (15 mL), sodium hydrogen carbonate saturated solution (10 mL) and more water (5 mL). Potassium cyanide (0.3 g, 4.6 mmol) and degassed water (10 mL) were added and the reaction was stirred for 24 hours at room temperature. The aqueous layer was removed and the dichloromethane solution was washed with degassed water (5×10 mL) then evaporated to dryness. 10 mL of anhydrous toluene were added and the solution was filtered under nitrogen through a 5 cm silica gel plug. Evaporation of the solvent gave 0.45 g of product (80 percent yield). All operations were carried out under nitrogen atmosphere. All aqueous solutions and contaminated glassware were quenched with bleach. The spectroscopic data resulted identical to the ones observed for the racemic mixture.

### EXAMPLE 19

### RuCl₂[(S)-MeOXylBIMOP][(S,S)-DPEN] and RuCl₂[(S)-MeOXylBIMOP][(R,R)-DPEN]

A Schlenk tube under nitrogen containing 70 mg (0.08 mmol) of (S)-MeOXylBIMOP and 25 mg (0.04 mmol) of [(p-cymene)RuCl₂]₂ and 5 ml of dry, degassed N,N-dimethylformamide was heated to 110° C. for 3 hours before 17 mg (0.08 mmol) of (S,S)-DPEN were added in portion. The dark brown solution turned yellow. The solution was stirred for 1 hour more, cooled to RT and the N,N-dimethylformamide removed under reduced pressure. The crude product was dissolved degassed acetone and filtered under nitrogen through a plug of silica; evaporation of the filtrate gave the product as a bright yellow solid. The yield was 46 mg, 45 percent. ³¹P NMR (162 MHz, CDCl₃) .δ 43.08 ppm.

A Schlenk tube under nitrogen containing 70 mg (0.08 mmol) of (S)-MeOXylBIMOP and 25 mg (0.04 mmol) of [(p-cymene)RuCl₂]₂ and 5 ml of dry, degassed DMF was heated to 110° C. for 3 hours before 17 mg (0.08 mmol) of (R,R)-DPEN were added in portion. The dark brown solution turned yellow. The solution was stirred for 1 hour more, cooled to room temperature and the N,N-dimethylformamide removed under reduced pressure. The crude product was dissolved degassed acetone and filtered under N₂ through a plug of silica; evaporation of the filtrate gave the product as a bright yellow solid. The yield was 42 mg, 42 percent. ³¹P NMR (162 MHz, CDCl₃) .δ 42.52 ppm.

### EXAMPLE 20

### RuCl₂[(rac)-3][EDA]

A Schlenk tube under N₂ containing 950 mg (0.89 mmol) of (rac)-3 (prepared according to U.S. Pat. No. 6,162,929) and 450 mg (1.4 mmol) of [(p-cymene)RuCl₂]₂ and 5 ml of dry, degassed N,N-dimethylformamide was heated to 110° C. for 3 hours before 0.5 mL (26 mmol) of EDA were added in portion. The dark brown solution turned yellow. The solution was stirred for 1 hour more cooling to room temperature and removing the N,N-dimethylformamide under reduced pressure. The crude product was dissolved degassed acetone and filtered under N₂ through a plug of silica; evaporation of the filtrate gave the product as a bright yellow solid. The yield was 173mg, 15 percent. ³¹P NMR (162 MHz, CDCl₃) .δ 50.32 ppm

General Hydrogenation Procedures

Hydrogenation: procedure A: the reactions were carried out in a 50 mL Parr hydrogenation vessel equipped with an injection port with a rubber septum for the addition of the solvent via syringe, a pressure gauge, a tightly fitting removable internal glass liner, and a magnetic stirring bar. The precatalyst (0.002 mmol) was placed in the glass liner and the vessel assembled. This was purged with nitrogen and then with hydrogen 5 times, by pressurising to 10 bar and releasing the pressure. A solution of acetophenone (721 mg, 6.00 mmol) in anhydrous, degassed 2-propanol (3 mL) was added through the injection port and the vessel was purged 5 times with hydrogen. A solution of potassium tert-butoxide in tert-butanol (1.0 M, 100 μL, 1.0 mmol) was added and the vessel was purged 5 times with hydrogen. The reaction pressurised to 10 bar and was vigorously stirred at room temperature until no further hydrogen was consumed.

Hydrogenation: procedure B: the reactions were carried out in 8-wells Argonaut-Endeavour apparatus. The precatalyst (0.002 mmol) was placed in the glass liners and the vessel assembled. This was purged with nitrogen 5 times, by pressurising to 10 bar and releasing the pressure. A solution of acetophenone (1.2 g, 10 mmol) in anhydrous, degassed 2-propanol (5 mL total volume) was added through the injection port. 1 mL of a solution of potassium tert-butoxide in tert-butanol and 2-propanol (0.1 M, 100 μL, 1.0 mmol) was added and the vessel was purged twice with nitrogen, then charged with nitrogen at low pressure (0.5 bar). The vessels are heated to 30° C. and pressurised to 10 bar hydrogen. The pressure is automatically maintained and the total consumption of hydrogen recorded.

Conversions and enantiomeric excesses were determined using chiral GC (Chirasil DEX-CB column; 100° C. for 7 min, then 15° C./min to 200° C.: 9.9 min (R), 10.1 (S)) analysis. The stereochemistry of 1-phenyl-ethanol was assigned by comparison with commercially available (R)-1-phenyl-ethanol (Aldrich).

### EXAMPLE 21

### Comparison of Racemic Xyl-TetraPHEMP and BINAP Catalysts in Acetophenone Hydrogenation

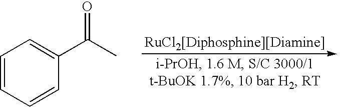

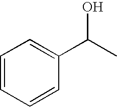

| | | Time | Conv. | e.e. |
|---|---|---|---|---|
| Phosphine | Diamine | (min) | (%) | (%) |
| rac-TetraPHEMP | EDA | 33 | >99 | — |
| rac-BINAP | EDA | 64 | >99 | — |
| rac-TetraPHEMP | (S,S)-DPEN | 38 | >99 | 46(R) |
| rac-BINAP | (S,S)-DPEN | 177 | >99 | 46(R) |

### EXAMPLE 22

### Comparison of Racemic Xyl-TetraPHEMP and rac-7 Catalysts in Acetophenone Hydrogenation

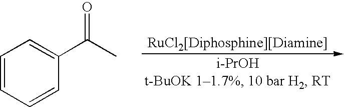

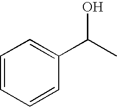

| | | Catalyst | Time | Conv. |
|---|---|---|---|---|
| Phosphine | Diamine | loading(S/C) | (h) | (%) |
| rac-XylTetraPHEMP | EDA | 3000 | 0.5 | >99 |
| rac-7 | EDA | 3000 | 3 | <1 |
| rac-7 | EDA | 5000 | 18 | <1 |

### EXAMPLE 23

### Hydrogenation of Acetophenone with RuCl₂[XylTetraPHEMP][DPEN]Complexes

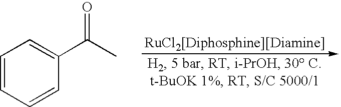

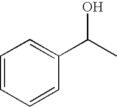

| | | Catalyst | | | |
|---|---|---|---|---|---|
| | | loading | Time | Conv. | e.e. |
| Phosphine | Diamine | (S/C) | (h) | (%) | (%) |
| (R)-XylTetraPHEMP | (S,S)-DPEN | 5000 | 5 | 89 | 54(S) |
| (R)-XylTetraPHEMP | (R,R)-DPEN | 5000 | 5 | >99 | 99(S) |

### EXAMPLE 24

### Hydrogenation of Acetophenone with RuCl₂-MeOXylBIMOP-DPEN Complexes

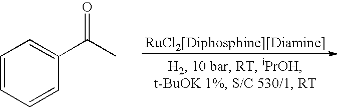

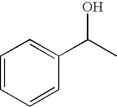

| | | Catalyst | Time | Conv. | e.e |
|---|---|---|---|---|---|
| Phosphine | Diamine | loading(S/C) | (h) | (%) | (%) |
| (S)-MeOXylBIMOP | (R,R)-DPEN | 530 | 12 | >99 | 66(R) |
| (S)-MeOXylBIMOP | (S,S)-DPEN | 530 | 12 | >99 | 95(R) |

### EXAMPLE 25

### Hydrogenation of 4M Acetophenone at 5000: Comparison of Catalysts

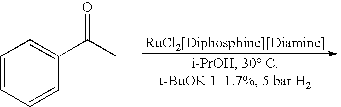

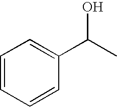

| | | Catalyst | | | |
|---|---|---|---|---|---|
| | | loading | Time | Conv. | e.e |
| Phosphine | Diamine | (S/C) | (h) | (%) | (%) |
| (S)-XylPhanePhos | (R,R)-DPEN | 5000 | 3.5 | >99 | 97(R) |
| (R)-XylTetraPHEMP | (R,R)-DPEN | 5000 | 3.5 | 90 | 98(S) |
| (S)-XylHexaPHEMP | (S,S)-DPEN | 5000 | 3.5 | 88.1 | 99(R) |
| (R)-HexaPHEMP | (R,R)-DPEN | 5000 | 3.5 | 99 | 83(S) |
| (R)-BINAP | (R,R)-DPEN | 5000 | 3.5 | 7.1 | 79(S) |

### EXAMPLE 26

### Hydrogenation of 2M Acetophenone at S/C 5000: Comparison of Catalysts

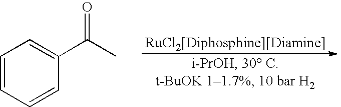

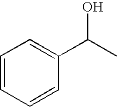

| | | Catalyst | | | |
|---|---|---|---|---|---|
| | | loading | Time | Conv. | e.e |
| Phosphine | Diamine | (S/C) | (h) | (%) | (%) |
| (S)-MeOXylBIMOP | (S,S)-DPEN | 5000 | 3 | >99 | 97(R) |
| (R)-XylTetraPHEMP | (R,R)-DPEN | 5000 | 3 | >99 | 99(S) |
| (S)-XylHexaPHEMP | (S,S)-DPEN | 5000 | 3 | >99 | 99(R) |
| rac-7 | EDA | 5000 | 12 | <1 | 0 |

### EXAMPLE 27

### Hydrogenation of 2-acetyl-pyridine

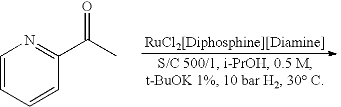

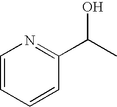

| | | Time | Conv. | e.e. |
|---|---|---|---|---|
| Phosphine | Diamine | (h) | (%) | (%) |
| (S)-Xyl-HexaPHEMP | (S,S)-DPEN | 20 | 68 | 76 |
| (R)-Xyl-TetraPHEMP | (R,R)-DPEN | 20 | 70 | 86 |
| (S)-Xyl-MeO-BIMOP | (S,S)-DPEN | 18 | 73 | 52 |

### EXAMPLE 28

### Hydrogenation of 2-methyl-benzophenone

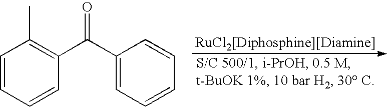

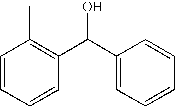

| | | Time | Conv. | e.e. |
|---|---|---|---|---|
| Phosphine | Diamine | (h) | (%) | (%) |
| (S)-Xyl-HexaPHEMP | (S,S)-DPEN | 20 | >99 | 51 |
| (R)-Xyl-TetraPHEMP | (R,R)-DPEN | 20 | 98 | 62 |
| (S)-Xyl-MeO-BIMOP | (S,S)-DPEN | 18 | 95 | 62 |

1. An enantiomerically-enriched compound of formula 4 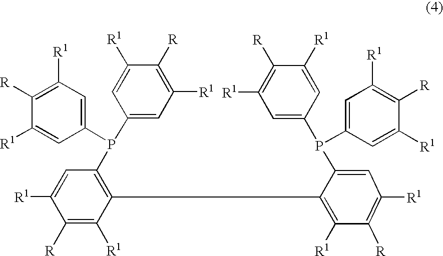
or the opposite enantiomer thereof, wherein
R is selected from the group consisting of H, alkyl, alkoxy, aryl, heteroaryl, N-alkyl,
N-aryl, S-alkyl, S-aryl, OSi(alkyl)₃, OSi(aryl)₃, F and Cl; and
R¹ is alkyl.

2. A compound according to claim 1 wherein R¹ is methyl.

3. A compound according to claim 2 wherein R is H.

4. A compound according to claim 2 wherein R is methoxy.

5. A transition metal complex of a compound according to any preceding claim.

6. A complex according to claim 5, wherein the metal is ruthenium.

7. A complex according to claim 6, having the formula Ru(4)X₂(DIA), wherein DIA is a chiral diamine and X is selected from a group consisting of halide, carboxylate or hydride.

8. A complex according to claim 7, wherein X is halide.

9. A complex according to claim 8, wherein X Is chloride.

10. A method for the stereoselective hydrogenation of a substrate, which is conducted in the presence of, as catalyst, a complex according to any of claims 5-9.

11. A method according to claim 10, wherein the substrate has at least one C═O or C═N bond that is hydrogenated.

12. A method according to claim 11, wherein the substrate is a ketone and the product is a chiral alcohol.
